(19) United States
(12) Patent Application Publication
(10) Pub. No.: US 2019/0336799 A1
(43) Pub. Date: Nov. 7, 2019

(54) APPARATUS FOR REMOVAL OF PARTICULATES FROM AIR

(71) Applicant: TURBINATE TECHNOLOGIES LIMITED, Oyne, Aberdeenshire (GB)

(72) Inventors: Hugh MONTGOMERY, Solihull, West Midlands (GB); Josep GRAU, London (GB); Ben CROXFORD, London (GB)

(21) Appl. No.: 16/476,607

(22) PCT Filed: Jan. 18, 2018
(86) PCT No.: PCT/GB2018/050150

§ 371 Date: Jul. 9, 2019

(30) Foreign Application Priority Data
Jan. 18, 2017 (GB) 1700845.9

(51) Int. Cl. A62B 23/02; B01D 45/08

(52) U.S. Cl. CPC A62B 23/025; B01D 45/08

(57) ABSTRACT

A device for removal of particulates from a gas is provided. The device comprises: an inlet for receiving a flow of gas; an outlet from which the flow of gas can be expelled; and a labyrinthine path extending between the inlet and the outlet for passage of the flow of gas; wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet. The device may be part of a face mask. The volume of air in the device with a velocity magnitude below 1 ms−1 may be greater than 4% of the total volume of air in the device.

The present invention relates to an apparatus, such as a face mask, for removal of particulates from a gas, and to a related method for removing particulates from a gas. The gas may be air with the particulates being removed. This may for example be to prevent them from entering a person's lungs during breathing or to stop their release to the atmosphere.

Particulates within air and other gases are a particularly troublesome form of pollution since often they cannot be easily removed by chemical means such as catalytic converters and the like. In urban areas a major source of particulate pollution in the air is exhaust from vehicles, and diesel vehicles in particular are known to produce a large amount of small size particulates including so-called PM₁₀ particulates as well as particulates of smaller sizes (PM₅, PM_{2.5}, PM_{1.0} or smaller, i.e. ‘ultrafine particles’). Particulates are a particularly dangerous form of air pollution due to their ability to penetrate deep into the lungs and then to enter the blood stream to be distributed around the body. When inhaled, such particulates can be very damaging to health. They can cause cancer: The International Agency for Research on Cancer (IARC) and World Health Organisation (WHO) designate airborne particulates a Group 1 carcinogen. They can cause acute and chronic respiratory disease (e.g. exacerbations of asthma and of chronic obstructive pulmonary disease), and cardiovascular disease (such as strokes and heart attacks).

In 2013, a study involving 312,944 people in nine European countries revealed that there was no safe level of particulates and that for every increase of 10 μg/m³ in PM₁₀ particles the lung cancer rate rose 22%. The smaller PM_{2.5} particulates were found to be particularly deadly, with a 36% increase in lung cancer per 10 μg/m³, as they can penetrate deeper into the tissue of lungs. The WHO Guidelines on Air Pollution of 1999 suggested that these particulates contribute to 6250 premature deaths per 100,000 people, 3 million deaths per year of which 1 million were in Asia alone, 5150 cases of asthma per 1000 people, 40% of asthma attacks and 30% of hospital admissions with respiratory diseases. More recently, the World Health Organisation reported that outdoor air pollution caused 3.7 million deaths in 2012, in addition to the 3.8 million deaths caused by indoor air pollution. Such problems occur worldwide, in both poorer, developing and developed nations: The UK Royal College of Physicians reported (in 2016) that 40,000 people each year die in the UK from air pollution.

In the prior art, various types of filters have been proposed. For example, a face mask for medical use is disclosed in US 2008/295843 and similar filtering systems have been proposed in face masks for pedestrians and cyclists. Filters by their nature are effective at removing larger particles. However, filters are not as effective with small particulates, which can fit through the openings in the filter material. Improvements can be made by use of finer graded filters and by having materials that can absorb particulates when in contact, but this is at the expense of significantly increased resistance to airflow. This can make it impossible to make full use of this kind of device since, for example, if used in a face mask for breathing; although the user gains some protection from particulates, they are not able to breathe without significant effort, and physical activity is greatly restricted. Likewise, substantial pressure gradients draw air in ‘around’ the mask, reducing its efficacy. Finally, absorbent materials can rapidly become saturated with particles or with water vapour/condensate, with resulting declines in efficacy, and may not be readily reusable.

Other proposals have been made. In CN 103933682 a device for treatment of air consists of a labyrinthine path in conjunction with a water bubbler system. The air must pass through both the water and the labyrinthine path. The walls of the labyrinthine path are made of an absorbent material. According to CN 103933682 the combination of the water and the convoluted path through which the gas must flow has the result that both larger and smaller particles are removed via absorption. However, the need to pass the air through the water adds a significant resistance to the flow of gas, and again this means that the user needs to put in extra effort to breathe. Moreover, the device of CN 103933682 is large and cumbersome, as well as requiring the user to keep it upright due to the water reservoir. Consequently, although it is taught for personal use, it is clearly not very portable or wearable, especially during more intense physical activity such as cycling or running.

Devices are also known for removing particulates from other gases aside from air that is to be breathed directly. For example, systems have been proposed for removing particulates from exhaust gas in order to prevent pollutants from entering the atmosphere. The same disadvantages arise in relation to resistance to flow, and there is moreover an ongoing requirement for more effective removal of particulates since known products are not fully effective, especially for smaller sized particles.

There is hence a clear need for improved ways to remove particulates from air and also from other gases, for example by removing particulates at the point of entry to the body using a face mask or similar or by removing particulates as they are produced through treatment of exhaust gases and the like.

Viewed from a first aspect the invention provides a device for removal of particulates (e.g. urban pollution) from a gas, the device comprising: an inlet for receiving a flow of gas; an outlet from which the flow of gas can be expelled; and a labyrinthine path (e.g. utilising a series of barriers), extending between the inlet and the outlet for passage of the flow of gas; wherein the labyrinthine path is arranged to (in use) steer the flow of gas such that particulates in the flow of gas will impact on adsorption surfaces of the labyrinthine path arranged for adsorption of impacted particulates such that particulates in the gas are removed from the gas by impaction on the adsorption surfaces and/or bring the particulates into close proximity with the adsorption surfaces such that they will adhere to them, as (in use) the gas flows from the inlet to the outlet.

In a second aspect, the present invention may provide a method of removing particulates from a gas, the method comprising: providing a device for removal of particulates from a gas, the device comprising: an inlet for receiving a flow of gas; an outlet from which a flow of gas can be expelled; and a labyrinthine path extending between the inlet and the outlet for passage of the gas; passing a flow of gas through the device from the inlet to the outlet, wherein the labyrinthine path steers the flow of gas such that particulates in the flow of gas impact on adsorption surfaces of the labyrinthine path arranged for adsorption of impacted particulates such that particulates in the gas are removed from the gas by impaction on the adsorption surfaces and/or bring the particulates into close proximity with the adsorption surfaces such that they will adhere to them, as the gas flows from the inlet to the outlet.

The inventors of the present invention have realised that particulates, i.e. solid particles, in a gas can be effectively removed from a gas flow by providing adsorption surfaces that are positioned and/or the path is arranged so that there is impaction of the particles on the adsorption surfaces. The impaction of the particles on the adsorption surface removes the particles from the gas flow. The particles are removed from the gas by adsorption on the adsorption surfaces of the labyrinthine path.

The inventors have realised that the device can be arranged (e.g. appropriately sized with an acceptable pressure drop) so that may be used in a face mask to remove solid particulates.

Thus in a third aspect the present invention may provide a face mask comprising a device for removal of solid particulates from a gas, the device comprising: an inlet for receiving a flow of gas; an outlet from which the flow of gas can be expelled; and a labyrinthine path extending between the inlet and the outlet for passage of the flow of gas; wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet.

In a fourth aspect the present invention may provide a method of removing particulates from a gas, the method comprising: providing a face mask comprising a device for removal of solid particulates from a gas, the device comprising: an inlet for receiving a flow of gas; an outlet from which the flow of gas can be expelled; and a labyrinthine path extending between the inlet and the outlet for passage of the gas; passing a flow of gas through the device from the inlet to the outlet, wherein the labyrinthine path steers the flow of gas such that particulates in the gas impact on adsorption surfaces of the labyrinthine path arranged for adsorption of impacted particulates such that particulates in the gas are removed from the gas by impaction on the adsorption surfaces as the gas flows from the inlet to the outlet.

The inventors of the present invention have also realised that the efficiency of the particulate removal may be improved if in use, the volume of air in the device with a velocity magnitude below 1 ms⁻¹, and/or less than 10% of the average input air flow velocity, is greater than 4% of the total volume of air in the device.

Thus in a fifth aspect the present invention may provide a device for removal of particulates from a gas, the device comprising: an inlet for receiving a flow of gas; an outlet from which the flow of gas can be expelled; and a labyrinthine path extending between the inlet and the outlet for passage of the flow of gas; wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet, wherein in use, the volume of air in the device with a velocity magnitude below 1 ms⁻¹ and/or less than 10% of the average input air flow velocity, is greater than 4% of the total volume of air in the device.

In a sixth aspect the present invention may provide a method of removing particulates from a gas, the method comprising: providing a device for removal of particulates from a gas, the device comprising: an inlet for receiving a flow of gas; an outlet from which the flow of gas can be expelled; and a labyrinthine path extending between the inlet and the outlet for passage of the gas; passing a flow of gas through the device from the inlet to the outlet, wherein the labyrinthine path steers the flow of gas such that particulates in the gas impact on adsorption surfaces of the labyrinthine path arranged for adsorption of impacted particulates such that particulates in the gas are removed from the gas by impaction on the adsorption surfaces as the gas flows from the inlet to the outlet, wherein in use, the volume of air in the device with a velocity magnitude below 1 ms⁻¹ and/or less than 10% of the average input air flow velocity, is greater than 4% of the total volume of air in the device.

The particles may be removed from the gas stream primarily by being adsorbed onto the surfaces of the device. This adsorption may occur when the particles impact (i.e. hit) the surfaces of the device. More impaction of the particles on the surface of the device may occur when the boundary layer (i.e. the stationary layer adjacent to the walls) is thin and/or when there is a sufficient volume of slow flowing air in the device, e.g. greater than 4%. The deposition rate of particles may increase with reduced boundary layer thickness and/or increased volume of slow flow. The boundary layer may be thinner when the turbulence is higher. Increased turbulence may be achieved by having a continuously interrupted airflow through the device.

The amount of adsorption may be increased when the amount of impaction of the particles on the walls is increased and this may occur as the boundary layer thickness is reduced and/or as the volume of slow flow is increased.

Alteration in path direction and formation of areas with slow flow may be utilised to maximise the incidence of impaction/retention events.

Removal of particles from the gas stream and their adsorption on the walls may be characterized with a particle flux towards the walls. The concentration of particles on the wall may be zero (because they are adsorbed as soon as they collide with the wall) and may have a non-zero value at some distance from the wall. The difference between the zero-value at the wall and the non-zero concentration far from it may be called the “concentration boundary layer”, and it has a certain thickness. The particle flux towards the wall may be maximized when the thickness of the concentration boundary layer is minimized and/or when the volume of slow flow is optimised.

The concentration boundary layer may be minimised by (i) interrupting the flow with barriers to stop the development of the concentration boundary layer, because otherwise it may grow continuously (ii) interrupting the flow with barriers to increase the levels of turbulence, because turbulence may reduce the concentration boundary layer and/or (iii) using a rough or textured surface, because roughness may contribute to the attachment of the concentration boundary layer to the wall, thereby reducing its development.

The concentration boundary layer may be contained within the “viscous boundary layer”. This viscous boundary layer may be defined by the distance between the zero value at the wall and the non-zero value or “bulk” value. The viscous boundary layer concerns the air velocity whereas the concentration boundary layer concerns the concentration. The above three factors described as reducing the concentration boundary layer may reduce the “viscous boundary layer” which may thus reduce the “concentration boundary layer”.

Additionally or alternatively, the removal of particles may be improved by having sufficient volume of slow flow in the device as it is being used. As the volume of slow flow is increased the percentage of particles removed from the gas flowing through the device may increase.

The volume of slow flow may be at least 4%, or at least 8% of the total volume of the device.

The present invention provides a device for removing small particulates (particularly those smaller than 10 microns (PM₁₀) or even smaller than 1 micron (PM₁)) from air by impaction on adsorption surfaces.

The device may be arranged to remove at least 30%, at least 35% or at least 39% of PM₁ particles.

Thus the device may be used to prevent an individual inhaling combustion related particulate matter and/or atmospheric aerosols.

The labyrinthine path may be arranged to increase bulk turbulence in the gas flow through the labyrinthine path and/or increase the volume of slow flow in the device. The turbulent airflow caused in the device may be used to remove or help remove particles from the gas flowing through the device.

The labyrinthine path may be arranged to prevent the formation of a developed boundary layer.

Preventing the formation of a developed boundary layer and/or increasing the bulk turbulence may increase the rate of impaction.

Increasing the volume of slow flow may increase the number of suspended particles that drop out of the air stream and thus that can be removed by the device.

The labyrinthine path may steer, or be arranged to in use steer, the flow of gas through and/or past multiple turns and/or branches with changes in the flow direction. Thus the labyrinthine path may prevent the air from travelling in a straight line through the device, in other words the gas may follow a tortuous path. These changes in the flow direction may be in any direction perpendicular or similarly opposed to the previous flow direction. For example, the angle between the new flow direction and the previous flow direction) may be at least (or about) 90 degrees. This is to cause the gas to impact on the walls such that the particles can be removed by impaction. This may for example be due to increased turbulence that results in impaction.

The turns may cause the bigger particles (that have more inertia) to impact the walls because they do not change direction with the gas flow before hitting a surface. Smaller may deposit because the turn increases turbulence and the small particles get trapped going in circles through turbulent eddies.

The device may be arranged so that in between the turns in the flow direction (e.g. in the straight sections of the flow path) there are areas of slow flow. This may be achieved by locating baffles in the flow path. Particles may be removed from the air stream by particles falling out of these regions with slow flow. Particulates in these slow flow regions may be attracted to and/or adhere to the surfaces of the device and/or sediment out of the air flow.

The walls of the labyrinthine path may include surfaces extending along the principal flow direction and (e.g. followed by) surfaces that are at least 90 degrees relative to (e.g. into or away from) the flow of gas, such that particulates in the flow of gas impact on the walls of the labyrinthine path.

Thus a seventh aspect the invention may provide a device for removal of particulates from a gas, the device comprising: an inlet for receiving a flow of gas; an outlet from which the flow of gas can be expelled; and a labyrinthine path extending between the inlet and the outlet for passage of the gas; wherein the labyrinthine path steers the flow of gas through and/or past multiple turns and/or branches with changes in the flow direction and the walls of the labyrinthine path include surfaces aligned with/extending along the principal flow direction followed by surfaces that interrupt the flow of gas (e.g. turn by at least 90 degrees), so as to prevent the formation of a developed boundary layer and increase the bulk turbulence, so as to (in use) increase the rate of impaction of particulates on the walls of the labyrinthine path; and wherein the walls of the labyrinthine path are arranged for adsorption of impacted particulates that contact with the adsorption surfaces such that particulates in the gas are removed from the gas by impaction on the adsorption surfaces as the gas flows from the inlet to the outlet.

In an eighth aspect, the present invention may provide a method of removing particulates from a gas, the method comprising: providing a device for removal of particulates from a gas, the device comprising: an inlet for receiving a flow of gas; an outlet from which the flow of gas can be expelled; and a labyrinthine path extending between the inlet and the outlet for passage of the gas; passing a flow of gas through the device from the inlet to the outlet, wherein the labyrinthine path steers the flow of gas through and/or past multiple turns and/or branches with changes in the flow direction and the walls of the labyrinthine path include surfaces aligned with/extending along the principal flow direction followed by surfaces that oppose the main direction of the flow (e.g. turn by at least 90 degrees) to interrupt the flow of gas, so as to prevent the formation of a developed boundary layer and increase the bulk turbulence, so as to (in use) increase the rate of impaction of particulates in the flow of gas impact on the walls of the labyrinthine path; and wherein the walls of the labyrinthine path are arranged for adsorption of impacted particulates that contact with the adsorption surfaces such that particulates in the gas are removed from the gas by impaction on the adsorption surfaces as the gas flows from the inlet to the outlet.

In a ninth aspect the invention may provide a device for removal of particulates from a gas, the device comprising: an inlet for receiving a flow of gas; an outlet from which the flow of gas can be expelled; and a labyrinthine path extending between the inlet and the outlet for passage of the gas; wherein the labyrinthine path steers the flow of gas through and/or past multiple turns and/or branches with changes in the flow direction of at least 90 degrees, and the walls of the labyrinthine path include surfaces extending along the principal flow direction followed by surfaces that turn by at least 90 degrees into or away from the flow of gas, such that particulates in the flow of gas impact on the walls of the labyrinthine path; and wherein the walls of the labyrinthine path are arranged for adsorption of impacted particulates that contact with the adsorption surfaces such that particulates in the gas are removed from the gas by impaction on the adsorption surfaces as the gas flows from the inlet to the outlet.

With the device of the invention, in contrast to known particulate removal devices, the primary mechanism for removal of particulates (i.e. the greatest percentage of the particulates removed are removed by this mechanism) is contact with, such as impaction on, an adsorptive surface. This may be as opposed to filtration, contact of the particulates with a liquid, or contact with absorptive surfaces such as porous surfaces.

The inventors have found that the use of a labyrinthine path with a geometry that promotes contact, such as impaction, in conjunction with adsorption at the walls, in favour of absorption, allows an increase in the effectiveness of the device in removing particulates from the gas, in particular small particulates. The device may also be arranged to minimise the pressure drop through the device, i.e. minimise the resistance to the flow of gas from the device. The pressure drop may be less than 140mmH₂O for example.

The device may allow a high flow (for example up to 3001/minute) at a relatively low pressure gradient. For example the pressure drop may be less than 70 mbar, less than 50 mbar, less than 25 mbar, less than 10 mbar or less than 5 mbar.

It has been realised that the device may be used to remove particles in a face mask of some other device that a person breathes through if the volume of slow flow is greater than 4% whilst the pressure drop is less than 10 mbar. It has been found that devices can be designed to meet these constraints whilst achieving filtration of PM₁ particles of greater than 35% or greater than 39%. The optimum volume of slow flow volume in the device may be a compromise between filtration and pressure drop through the device.

For example, when the volume of slow flow is greater than 4%, removal of ultra-fine particles (PM₁) (representative of ISO 12103-1 A1 Ultrafine Test Dust) can be 40% or greater for a device with two 180 degree turns. The device may have a low pressure drop, e.g. less than 10 mbar, even with two 180 degree turns in the flow path.

Slow flow velocity may be defined as when the air has a velocity magnitude of below 1 ms⁻¹.

The device may comprise a fan/impeller and/or a(nother) powered device to increase gas flow rates through the device. An increased air flow rate through the device may improve the deposition processes.

Adsorption is the adhesion of a substance to a surface. This process creates a film of the adsorbate (the molecules, atoms or particles being accumulated) on the surface of the adsorbent. It differs from absorption, in which a substance permeates or is dissolved by the material of the absorbent.

The use of impaction surfaces is inspired by biomimicry, since the human respiratory system uses the same approach to capture particles from air as it is breathed into the lungs. The presence of increasing amounts of small particulates such as PM₁₀ particles and smaller sized particles can overwhelm the abilities of the respiratory system, but a device as proposed herein can adapt and improve on the impaction based removal of particulates, such as by having at least 4% volume slow flow in the device, hence being usable to make air safer to breathe. The proposed device may remove a large range of solid and liquid contaminants from gases and the advantages of the device, although focussed on removal of smaller particulates, are not limited only to such particulates.

The device may remove inhaled droplets or dry, solid particulates across a range from macroscopic (>1 mm) to small PM_{2.5} particles (<2.5 micron diameter) and smaller, including ‘ultrafine’ particles (diameter <1 micron).

The device may remove greater than 90%, or greater than 80% or greater than 60%, greater than 50%, greater than 40%, or greater than 35% of the particles in the air passing through the device.

Moreover, since the particulates may be retained by adsorption (caused by impaction) rather than absorption, they can easily be cleaned from the surfaces of the labyrinthine path, for example by flushing with water or another solvent. The cleaning of the device may not be during the normal mode of operation but rather may be when the device is not in use and is being cleaned.

Thus the device may be cleaned/‘renewed’ by washing the device with a solvent such as water.

The device may be a reusable device, such as a cartridge type device, which can be removed for cleaning and then reinserted into an apparatus such as a face mask or other air cleaning unit.

The device may have a removable cover (that may be one side of the device) to permit cleaning of the labyrinthine path. This may allow convenient cleaning.

The device may be a disposable device that is designed to be used a certain number of times, such as one day, one week or one month, and then be disposed of.

The labyrinthine path may be provided at least in part by a cardboard insert. The cardboard insert may for example form a lattice which opens up from flat pack. This may be housed in a shell to form the device. The cardboard may be coated, such as with the materials discussed below. This may allow the cardboard insert to be used more than once.

The device may not remove particulates by absorption. For example, the device may not have any absorptive (e.g. porous) surfaces. Alternatively, if the device does comprise absorptive surfaces, the primary mechanism for removal of particulates may be by adsorption. The advantages of having no absorptive surfaces or absorption not being the primary mechanism for removal is that the device may have surfaces that are easier to clean. This may extend the useful life of the device.

Viewed from a tenth aspect the invention provides a device for removal of particulates from a gas, the device comprising: an inlet for receiving a flow of gas; an outlet from which the flow of gas can be expelled; and a labyrinthine path extending between the inlet and the outlet for passage of the gas; wherein the labyrinthine path steers the flow of gas such that particulates in the flow of gas impact on deposition surfaces of the labyrinthine path arranged for deposition (by adsorption and/or absorption for example) of impacted particulates such that particulates in the gas are removed from the gas by impaction on the deposition surfaces as the gas flows from the inlet to the outlet. The device may have a continuous gas path from the inlet to the outlet, i.e. it may have a volume continuously filled by gas, without any section composed wall-to-wall of a different material. For example, the gas may not pass through a fluid.

In an eleventh aspect, the present invention may provide a method of removing particulates from a gas, the method comprising: providing a device for removal of particulates from a gas, the device comprising: an inlet for receiving a flow of gas; an outlet from which the flow of gas can be expelled; and a labyrinthine path extending between the inlet and the outlet for passage of the gas; passing a gas through the device from the inlet to the outlet, wherein the labyrinthine path steers the flow of gas such that particulates in the flow of gas impact on deposition surfaces of the labyrinthine path arranged for deposition (by adsorption and/or absorption for example) of impacted particulates such that particulates in the gas are removed from the gas by impaction on the deposition surfaces as the gas flows from the inlet to the outlet. The device may have a continuous gas path from the inlet to the outlet, i.e. it may have a volume continuously filled by gas, without any section composed wall-to-wall of a different material. For example, the gas may not pass through a fluid.

The labyrinthine path of the invention may include multiple flow paths coupled together in parallel between the inlet and the outlet of the device. Each flow path may have its own inlet and/or outlet. Alternatively, one or both of the inlet and outlet for each of the flow paths may be common inlet or outlet. Each of the flow paths may be separated from each other by a wall. Alternatively, the labyrinthine path may be a single flow path (although the gas may flow in many different directions (concurrently) within the single flow path) that extends between the inlet and the outlet.

The path between the inlet and the outlet may be a serpentine path. The serpentine path may have portions that extend (relative to the net gas flow) in opposite directions to each other. For example, the path may include one or more 180 degree turns. The primary (i.e. net) flow directions may be opposite to each other in different portions of the device. This may allow the device to be compact whilst having a long flow path and direction changes to cause impaction of particles in the gas on the adsorption/deposition surfaces of the device. This may also help to increase the surface area in the labyrinthine path so as to aid removal of the particulates. The labyrinthine path may be a serpentine path.

The device may be arranged to extend the air path. This is so that there is an increased length (and hence surface area) for the particles to be removed from the device.

The number of 180 degree turns may be of an even number such that the inlet and outlet are disposed at opposite sides of the device. The inlet and outlet may be at opposite sides and opposite ends of the device (i.e. at opposite, diagonal corners of the device to each other)

The flow path(s) through the labyrinthine path may include at least two, three, four, five, six, eight, nine or twenty branches and/or turns. For example, the flow path(s) may have between one and six changes in direction of at least 90 degrees. The flow path(s) through the labyrinthine path may include an odd number of branches and/or turns. This may be so that the inlet and outlet can be opposed to each other. The branches and/or turns may be at least 45 degrees, at least 60 degrees or at least 90 degrees. A larger turn count may increase the probability of contact of the particles with the adsorption/deposition surface. Therefore, the number of turns may be a compromise between the efficiency of the removal device and an acceptable pressure drop through the device.

Where branches are present then these branches may be mainly for capture of particulates rather than for through-flow of the gas. The branches may be cul-de-sacs (i.e. dead ends), recesses and/or corners. These branches may create volumes of slow flow.

The walls of the labyrinthine path in the flow path(s) may have multiple instances of surfaces that extend at least 45 degrees, at least 60 degrees or at least 90 degrees into or away from the flow of gas, for example there may be at least ten or at least twenty such turns of the surfaces of the walls.

The desired number of turns and/or volume of slow flow may depend on the desired balance between removal efficiency of the particles and the acceptable pressure loss through the device.

The walls at the turns may be curved or they may be corners with edges. The turns in the flow direction, the branches in/from the flow direction, and/or the turns in the walls may be provided by (or provide) a maze-like structure.

Protrusions, such as baffles, vanes, pegs etc., may be provided that extend into or across the flow path from any number of surfaces/walls of the channel through which the gas is passing. These protrusions may create the labyrinthine path and/or be provided within a labyrinthine path. These protrusions may provide/create the turns and branches in the flow path and/or create additional turns and branches. The protrusions may create bulk turbulence in the flow from the inlet to the outlet. The protrusions may create regions with slow flow.

The protrusions, e.g. baffles, may be located, e.g. suspended, in the air flow path. The protrusions may be located such that a clear line of sight can be seen along at least one, two, three, four or all edges of the path until each turn. The protrusions may provide particle removal by creating volumes of slow flow, such that suspended particles will drop out of the air stream.

Each protrusion may have area in the flow path between 10% and 90%, 30 and 70% or about 50% of the path cross sectional area.

The spacing between each protrusion may be between 50% and 300% of the cross sectional diameter of the flow path. The diameter in the case of a non-circular flow path may be the diameter of a circle with a cross sectional area equal to the cross sectional area of the flow path.

The protrusion, e.g. baffle, may be shaped between concave and convex. For example, the centre of each baffle may be deflected by no more than +/−75%, +/−50%, +/−25%, or +/−10%, of the width of the baffle from its edges. (E.g. for +/−75%, if the baffle is 10 mm×10 mm, then the centre would be deflected no more than 7.5 mm from the edges of the baffle in either direction)

The width of each of the members suspending the protrusion, e.g. baffle, in the path may be less than 20% of the width of the channel.

The protrusions, for example including baffles, vanes, pegs and the like, may direct the airflow and/or create regions of slow flow. In some examples the labyrinthine path includes structures, such as pegs that mimic the shape of the turbinate bones of the human nose.

The protrusions may for example be comma-shaped or c-shaped.

If the protrusion has a curved surface, this curved surface may face into the primary gas flow direction. This is so gas flowing through the path will hit the convex or concaved face of the curved surface so as to cause turbulence in the gas.

The protrusions may be located to reduce the distance that the gas can flow in a straight line.

However, the protrusions may leave a clear line of sight along the walls of sections of the flow path between turns in the flow path. This may reduce the pressure drop through the device.

At least some of the protrusions may be provided at the surface (i.e. walls) of the path extending between the inlet and the outlet for passage of the gas.

The labyrinthine path may be designed to maximise the impaction of particulates on the deposition/adsorption surfaces and thus the geometry of the labyrinthine path may promote continuously interrupted flow of gas, that is, there is no way for the gas flow to travel in a straight line through the labyrinthine path and preferably not for any long distance through the path. For example, straight line passages within the labyrinthine path may be at most 10 mm in length.

Straight line passages within the labyrinthine path (e.g. in the net fluid flow direction) may be between 1 and 2 times or up to 2 or 3 times, the width of the path (i.e. the dimension that is perpendicular to the net gas flow direction).

The inventors have found that small particles such as the particulates of interest will deposit on surfaces across which they are passed at a greater rate if the “boundary layer” that is formed adjacent the wall is thinner. The relationship between the key variables may be illustrated from first principles. A simplified (1 dimensional) relationship between the boundary layer thickness (δ) and turbulence (Re) and the length of the flow path is (x) is:

δ=(0.382x)/Reₓ^{1/5}

To reduce δ requires high turbulence (high Re) and short lengths (short x). The labyrinthine path is hence designed to maximise Re and minimise the largest flow path lengths (x), whilst avoiding excessive increases in flow resistance. For example, in the case of a face mask the device is designed to operate within the constraints of human tolerable ventilatory pressure drops, as discussed below. Alterations in the path direction are utilised so as to maximise the incidence of impaction/deposition (i.e. retention) events.

At high velocities (with a high pressure loss) the boundary layer thickness may be smaller and therefore adsorption/deposition may be higher.

The device may comprise a plurality of parallel paths (such as four). Within each path there may be a plurality (such as four) protrusions that extend across the path and create the labyrinthine path. The protrusions may be comma-shaped and/or turbinate-shaped. The gaps between the protrusions may create branches with a change in flow direction (e.g. of at least 90 degrees) relative to the net flow direction. The protrusions may cause turbulence and/or a change of direction of the gas flow through the device so as to cause particles in the gas to impact of the surfaces of the device. This may allow removal of the particles from gas by adsorption on the surfaces of the device.

The device may comprise a serpentine path with two or more 180 degree turns in the flow path. The parts of the path between the 180 degree turns may be referred to as sections of the path, i.e. in the case of a serpentine path with two 180 degree turns there would be three sections of the path with the middle section being, with respect to the primary gas flow direction, in counter-flow arrangement to the first and last sections of the path.

Protrusions may be provided within the serpentine path and the serpentine path and protrusions may together form the labyrinthine path through which the gas flows.

The path may have a top and bottom separated by the height of the path and two sides separated by the width of the path.

The protrusions may be baffles. The baffles may extend from the walls of the path into the path. The baffles may extend across the entire width of the path and extend partially into the path across the height of the path or vice versa. One or more, or each baffle may extend into at least 25% of the path, at least 50% or about 60% in one direction. Baffles may be provided on opposite surfaces (such as the top and bottom) of the path at offset locations along the flow path. The baffles may be located with alternating top and bottom baffles along the length of the path. This may cause the gas to follow a tortuous path over the bottom baffles and under the top baffles alternately.

The distance the baffles extend into the path may be at least 50% or at least 60% so that there is no straight line along each section of the serpentine path. In other words, the baffles that extend from opposite directions may overlap (e.g. in the height direction of the path) so as to help ensure that there is no straight line for gas flow through the device.

The baffles may alternate between extending from a first side towards a second opposite side, from the top or bottom towards the other of the bottom or the top, from the second side towards the first side, and from the other of the bottom or the top towards the other of the top or the bottom of the path. Thus baffles may extend left to right, right to left, top to bottom and/or bottom to top. In other words the baffles may divert the local air flow towards any direction perpendicular to the direction of the net flux of air.

The baffles extending from the sides may extend across part of the width and the entire height of the path and the baffles extending from the top or bottom may extend the entire width and into part of the height of the path. With this arrangement the gas flowing through the device may be forced/steered towards one side of the path and then towards the top or bottom of the path, then towards the other side of the path and then towards the other of the bottom or the top of the path.

Alternatively, the baffles may be located in the middle of the flow path. This may leave at least a portion of each of the walls without any baffle protruding therefrom. The path may additionally or alternatively be provided with protrusions in the form of ridges that extend across and from a surface of the path. These ridges may form recesses at the surface of the path. These ridges and recesses may help to minimise the thickness of the boundary layer that forms at the walls of the path.

The device may comprise protrusions in the form of pegs, such as curved, e.g. c-shaped pegs, that extend across the path. The curved/concave surface of the protrusion may face into the oncoming gas flow. This may increase the turbulence in the gas flow.

The pegs may be located so that there is no straight path through a section of the path without hitting a peg. The pegs may be located at offset heights along the length of the path. For example, at a first location one peg may be located in the middle of the path, at a second location further along the path two pegs may be located in the path at locations above and below the first peg and at a third location yet further along the path pegs may be provided at the opposite surfaces of the path. This pattern may repeat along the length of the path. The height of the peg(s) (i.e. dimension in the height direction of the path that maybe perpendicular to the direction in which the pegs extend across the full width of the path) may be a third of the height of the path. This may give a suitable compromise between promoting impaction of the gas on the surfaces whilst creating an acceptable pressure drop through the device.

The walls of path (e.g. in sections of the serpentine path) may be angled relative to the net gas flow direction of the section. For example, the walls may be angled into and out of the path alternately to create a zig-zag shaped path e.g. in each section of the serpentine path. The peaks of the top and bottom surfaces that are at laterally offset locations along the path may extend past each other into the height of the path, e.g. beyond the mid-point from each direction, such that there is not a straight path along each section of the serpentine path that can be taken by gas flowing through the path. The angled top and bottom surfaces may cause the gas to flow in a zig-zag path along the path.

There is a gas flow path through the device from the inlet to the outlet. In addition to, or as a part of, the labyrinthine path the gas flow path may include a 90 to 180 degree change in the gas flow direction between the inlet and the outlet. This bend may be located at or towards the outlet of the device. Such a change in direction can mimic changes in direction in airflow the human respiratory system, such as the bend as air enters the throat. The gas flow path of the device may include an elbow bend of between 90-180 degrees, or optionally 120 to 180 degrees before, after or within the labyrinthine path.

This bend may be additional to the bends of the serpentine path (if present). This additional bend may be out of (i.e. away from) the plane of the serpentine path.

This bend may have walls with an adsorptive surface at least at the outside of the curve and this may allow for further capture of particulates. Preferably the flow of gas is substantially unimpeded at either the entrance or the exit to the bend. This maximises the flow rate through the bend and hence increases the impaction of particulates. In one example the bend is placed after the labyrinthine path and immediately before the outlet. The labyrinthine path may also have a change in flow direction of the gas between the two ends of the labyrinthine path and thus a change in flow direction of the gas within the labyrinthine path may contribute to an overall change in direction of the flow path between the inlet and the outlet of the device.

The device may have a continuous gas path from the inlet to the outlet, i.e. it may have a volume continuously filled by gas, without any section composed wall-to-wall of a different material. For example, the gas may not pass through a fluid. The path may be unimpeded by liquids, for example there may be no bubbling of the gas through water or the like. The use of a liquid, as in CN 103933682 for example, may result in undesirably high resistance to the flow of gas. It has been realised that this water is not necessary to remove particulates, and in particular small and/or ultrafine particulates, from a gas if the gas is steered such that it hits the surfaces so that particles are removed by impaction and/or adsorption.

The device may not comprise a filter (i.e. mesh type device) which can impede the flow.

Bristles (e.g. fibres and/or hairs) may be located across the path, e.g. at or near, the inlet of the device. These bristles may be a removal device for larger particles. These bristles may aid in the primary removal of large particles (such products of pavement and brake attrition, fibers or macroscopic dust).

With a labyrinthine path using impaction and adsorption surfaces as discussed above it has been found that it is possible to remove particles very effectively without the need for water, other liquids and/or a mesh type filter. This means that a relatively low resistance to flow of gas can be obtained along with a high rate of capture of particles from the gas. In the present invention the gas is forced/steered to follow a tortuous path and thus may be forced to hit walls of the device and/or forces in to regions of slow flow. This is through an otherwise unimpeded path (e.g. the device may have a continuous gas path from the inlet to the outlet, i.e. it may have a volume continuously filled by gas, without any section composed wall-to-wall of a different material. For example, the gas may not pass through a fluid) such that the pressure drop through the device is minimised and/or kept to an acceptable limit.

Thus the device of the invention may replicate the action of the turbinate bones by creating a low resistance turbulent airflow.

The device of the invention may have only one purification stage which may be a dry purification stage.

The device may be a passive device. The device may operate without a pump or power source.

In some examples the gas flow path extends from the inlet to the outlet without any physical barrier. That is to say, whilst the flow path includes multiple changes in direction and/or branches, the flow of gas does not need to flow through any physical barrier such as a filtering medium, for example a liquid or a membrane. Preferably the flow of gas does not need to pass through any physical barrier with a maximum pore or opening size of less 0.5 mm², less than 2 mm² or not less than 25 mm², Note however that in some cases it is advantageous to include a barrier to flow in the opposite direction, i.e. from the outlet to the inlet. There may therefore be a one-way valve (such as a flutter valve) in the gas flow path, the valve being arranged to permit airflow from the inlet to the outlet and to restrict or prevent airflow from the outlet to the inlet. Suitable valves are known for use with face masks, such as face masks for medical purposes and so on.

The walls of the labyrinthine path may be arranged for adsorption of particulates and in some examples the walls may not be capable of absorption of the particulates. Thus, it may be ensured that adsorption is the primary mechanism of capture of the particulates. The adsorption surfaces may be at the outside of changes in direction of the gas flow path(s) in the labyrinthine path, and in some cases all walls of the labyrinthine path may be made of a material selected for adsorption of particulates, such that all walls are capable of adsorption. It will of course be understood that the geometry of the labyrinthine path promotes impaction at certain regions of the wall but nonetheless it can be an advantage to make all wall surfaces capable of and/or designed for adsorption. This can make for easier manufacture of the labyrinthine path since a single material may be used.

The adsorption/deposition surfaces, which may be all walls of the labyrinthine path, may comprise a textured, roughened or fibrous surface. The advantage of the use of rough surfaces may be twofold: 1) increasing the surface area in this way may increase the rate of adsorption, and 2) the use of this type of surface finish may also reduce the size of the boundary layer, which promotes impaction. Such features may vary in size and scale from macroscopic curves, ripples, ridges and point elevations through to these same features at microscopic level (which might be considered as ‘roughness’ of the surface.

In some examples the surface may have ridges of 0.1 mm-1 mm, for example ridges of about 0.5 mm or smaller than a twentieth of the width and/or height of the path, with spacing of between one and ten times the ridge height.

The device may comprise obstacles to air flow of two different scales: one size of protrusions/obstacles which are of the scale of the path width (e.g. from 25% to 75% width of the path), and another size of protrusions/obstacles which are of a scale less than a 1/10^{th} of the path width. The larger sized protrusions/obstacles may be for 1) creating large scale turbulence, (2) avoiding growth of the boundary layer and/or (3) creating regions of slow flow, and the smaller sized protrusions/obstacles may be for attaching the boundary layer to the wall.

The walls of the path may have a rough surface (e.g. a range of roughness from sub-millimetre to macroscopic (e.g. of the order of centimetres) features such as ridging and folds). This may help reduce path lengths and/or increase attractive forces between the particulates and the surfaces so as to aid the removal of particulates from the gas stream. The roughness may reduce the boundary layer thickness which as explained above may increase the particulate deposition rate. Surface roughness may be achieved both through alterations in the surface texture (for example protrusions significantly larger than the size of the particles, e.g. 101 to 1 mm), larger-scale form of surfaces (e.g. the pattern in which protuberances lie, such as ripples or lines) and/or the shape of the surfaces (such as rolling surfaces).

The walls (which may be roughened) may be a naturally rough surface. The walls may in use be dry or designed to be dry. The walls may be a hard surface.

The walls, or at least part of the walls may have a wet or sticky surface. This may be achieved by a gel or liquid that is applied to the internal surfaces of the labyrinthine path such as by spraying.

The internal surfaces may mimic the effect of mucous in the human respiratory system. This may have the effect of aiding the removal of particles from the gas flowing through the device.

This may enhance adsorption though increasing the adherent properties of the surface.

The walls of the labyrinthine path may comprise or consist of non-porous and/or non-absorptive materials, for example polymer plastics materials such as Acrylonitrile butadiene styrene (ABS), Polypropylene (PP) or high density polyethylene (HDPE). The walls may be formed from these materials and/or may be coated with these materials to obtain the beneficial effects of these materials.

The surfaces may be coated to increase particle adherence. This may be due to the coating altering characteristics including, but not limited to, roughness and/or electrostatic charge.

The permeability for water (at 25° C.) of the material of the walls may be no more than 100×10⁻¹³ cm³·cm cm⁻²s⁻¹Pa⁻¹, and preferably less than 50×10⁻¹³ cm³·cm cm⁻²s⁻¹Pa⁻¹. The permeability for air (at 25° C.) of the material of the walls may be no more than 2×10⁻¹³ cm³·cm cm⁻²s⁻¹ Pa⁻¹ and preferably less than 1×10⁻¹³ cm³·cm cm⁻²s⁻¹ Pa⁻¹. This may avoid or minimise moisture and gas transport through the material.

ABS may be used in view of the combination of properties for ABS including low permeability.

The material of the walls of the labyrinthine path may also be used for the remaining parts of the labyrinthine path. The material is selected for its ability to provide adsorptive surfaces and may be selected for its ability to be manufactured with a textured, roughened or fibrous surface as discussed above.

Surface retention of particles may be enhanced through the use of materials that have a high surface electrical resistivity. Thus the walls may comprise (e.g. be made from or have a coating of) a material with a high surface electrical resistivity. This means that the surface does not absorb charge, and static electricity will thus accumulate on its surface. In this case, adsorption may still be the primary mechanism by which the particles are removed but the static may aid this removal process. Polymers such as those mentioned above may provide good surface electrical resistivity properties.

The surfaces of the device may be electrostatically charged to help aid removal of the particles from the gas stream. Again, adsorption may still be the primary mechanism by which the particles are removed but the charge may aid this removal process.

The material may have antibacterial and/or antiviral properties. For example, the internal walls of the device may be made from a material, such as a plastic, that is antibacterial and/or antiviral. When the device is used for air being directly breathed in by a user (such as in a face mask) the device may offer some protection against the spread of infection.

The device and/or the labyrinthine path may be manufactured by moulding or machining in some instances. Injection moulding is one possible manufacturing method. Injection moulding can be used to form fine details in the surfaces of components and it is a method that is well-developed for use with the preferred materials.

Additive manufacturing techniques (including so-called ‘3-D printing’) may be used. The additive manufacturing process may be such that the surfaces will have a grainy texture, which can be beneficial as noted above. Additive manufacturing also allows for complex geometries, including internal structures, which allows for greater freedom of design for the labyrinthine path and can permit a single manufacturing step to be used to make the labyrinthine path in a single part, thus avoiding any later assembly steps. In some examples the labyrinthine path is hence a single part manufactured by additive manufacturing. This may include the use of 3-D printed plastics.

The device may be used in a variety of applications. The applications may be for cleaning air that is about to breathed in by a person such as in a face mask, building air conditioning/air supplies. This may for example be indoor (e.g. building sites, home renovation, factories, particularly those where there may be exposure to particles such as brick dust, plaster dust etc. or in a vehicle such as an aircraft), in mining, outdoors, e.g. to remove pollen (to help protect from hay fever), at railway stations, and dust in agricultural workers environments. The applications may be for cleaning air at or near the source where the pollutants are created to prevent them being released into the atmosphere, e.g. chimney stacks at factories and power stations, and combustion engine exhausts (whether automobiles or generators, for example).

The device may be incorporated into a face mask for a person. The device may be an integral part of the face mask. Preferably, the device is held on or about the face along with the other parts of the face mask. Thus, the face mask advantageously does not require any other parts remote from the face mask, such as the separate housing of CN 103933682 and similar devices. The proposed face mask may be for use whilst exercising.

Thus, in a twelfth aspect, the present invention may provide a face mask, the face mask comprising one or more (such as two) device(s) for removal of particulates from a gas, each device comprising: an inlet for receiving a flow of gas; an outlet from which the flow of gas can be expelled; and a labyrinthine path extending between the inlet and the outlet for passage of the gas; wherein the labyrinthine path steers the flow of gas such that particulates in the flow of gas impact on adsorption surfaces of the labyrinthine path arranged for adsorption of impacted particulates such that particulates in the gas are removed from the gas by impaction on the adsorption surfaces as the gas flows from the inlet to the outlet.

In a thirteenth aspect, the present invention may provide a method of removing particulates from a gas, the method comprising: providing a face mask, the face mask comprising one or more (such as two) device(s) for removal of particulates from a gas, each device comprising: an inlet for receiving a flow of gas; an outlet from which the flow of gas can be expelled; and a labyrinthine path extending between the inlet and the outlet for passage of the gas; passing a gas through the device from the inlet to the outlet, wherein the labyrinthine path steers the flow of gas such that particulates in the flow of gas impact on deposition surfaces of the labyrinthine path arranged for deposition (by adsorption and/or absorption for example) of impacted particulates such that particulates in the gas are removed from the gas by impaction on the deposition surfaces as the gas flows from the inlet to the outlet.

The device may be the device as described above and may include one or more of the above described optional features.

The device may be integral in the face mask that sits on the face of a user.

The device may help to prevent entrainment of air around the sides of the mask during use rather than through the device itself. This may be achieved because the device provides a low resistance flow path for gas. This means that upon inhalation air may be drawn in preferentially through the device rather than around the sides of the face mask.

The inlet(s) for the particulate removal device used for example in a face mask may face rearward (in use) relative to the face of the user. Rear facing inlets may help to avoid forced breathing of exhaust fumes when a user is traveling behind a vehicle.

The outlet may face toward, or to a location in front of (such as in close proximity to), the mouth and nose of the user at the inside of the face mask.

The face mask may have a short, protected path for exhalation. This may allow efficient exhalation. Also, the protected path means that few, if any, contaminants may enter the face mask through the exhalation path.

The face mask may have an exhale valve that allows exhaled air to exit the face mask without going back through the device. The exhale valve may be located in front of the nose and mouth of the user.

The face mask may comprise inlet and outlet one-way valves (that may be flutter valves for example). The inlet valve may be arranged to permit airflow from the inlet of the device to the outlet of the device and to restrict or prevent airflow from the outlet to the inlet. The outlet valve may be arranged to permit exhaled air to exit the face mask and to restrict or prevent air flow from the outside environment without going through the device. When the pressure is low in the face mask (such as during an inhalation by the user) air may be drawn in through the device through the inlet valve and when pressure is high in the face mask (such as during exhalation by the user) air may be forced out through the outlet valve.

The outlet of the device may be directed on to an internal surface of the face mask that is (in use) in front of the nose and/or mouth of the user. Owing to the fact that this internal surface will receive warm wet air on each exhale, this surface will be wet. The face mask and device may be arranged so that air exiting the device is directed onto this surface. The surface of the internal surface may be a different surface to that encountered by the air on the way through the mask. Thus, this surface may be used to remove particulates from the air that have not already been removed by the device.

The face mask may be designed to firmly fit around the nose and mouth of a user whilst exposing the maximum amount of facial area for cooling and comfort.

The face mask may comprise material with antibacterial properties as discussed above.

The face mask may include an eye shield so as to, at least partially, also protect the eyes from the external environment.

As noted above, the features of the current device allow for sufficient airflow at a low enough resistance to be used comfortably during exercise such as cycling or running. The device incorporated in the face mask may include a one-way valve of the type mentioned above that allows flow of air from the inlet to the outlet but restricts flow of air from the outlet to the inlet. In this way the incoming air can be passed through the labyrinthine path with particulates being removed before inhalation by the user, whereas the exhaled air can be expelled via another route, for example around the sides of the mask or through another one-way valve. This prevents build-up of moisture in the particulate removal device due to the moist exhaled air, and it also prevents fouling of the particulate removal device if the user coughs or sneezes. Further, limiting the size of the ‘dead space’ means that very little air is ‘rebreathed’, making use more comfortable and physiologically tolerable.

As noted above, the device can advantageously be designed to allow for gas flow (both inspiratory and expiratory) in line with the tolerances of human ventilation across varying workloads. The ranges may include (i) peak inspiratory flow rates of: up to 150 litres/minute or about 120 litres/minute (e.g. 125.6 litres/minute) in the case of light work, or up to 300 litres/minute or about 250 litres/minute (e.g. 2541 litres/min) in the case of heavy work and/or (ii) inspiratory resistances of <8 mm H₂O/L/sec (which is the detection limit for humans) or up to 35 mm H₂O/L/sec.

The device may be arranged to have a similar or smaller resistance to airflow as the upper airway of the user.

This allows for the device to be used to remove particulates from air for breathing both for normal levels of physical exertion and also for higher levels of physical exertion, for example during running or cycling. Different constructions can be provided to deliver the best compromise between efficient particulate removal and tolerability/‘breathability’ at different ranges of ventilatory rates and inspiratory/expiratory flow rates. Thus, efficiency might be sacrificed for ‘breathability’ in a ‘high work rate’ version. The device may be adapted depending on the likely demands, for example this may depend on the user, e.g. adult versions and child versions may be provided with different maximum flow rates, and/or the activity being done whilst wearing the mask, e.g. cycling, working in a factory or on a building site, walking etc.

The inspiratory and expiratory resistances of the device may be minimised, and held strictly within a range which does not engender significant discomfort or ventilatory fatigue on the user.

Similar choices of design may be made to accommodate other uses of the device other than in a face mask—such as in building ventilation, or removing particulates from exhausts. Ranges will depend on the precise application (e.g. the size of house or generator). But by way of example, gas flow rates might be about 34000 standard cubic feet per minute (CFM) (16000 litre per second) (e.g. 33753 CFM (15930 litre per second)) for the Caterpillar ‘3616’ engine, but 75 CFM (35 litre per second) for the Allis Chalmers 213 model. Diesel generator set engines from Caterpillar, Cummins, John Deere (15->1000 kW) have back pressure limits of 6.7-10.2 kPa, set depending on factors such as gas temperature, flow rates, turbocharger performance and fuel consumption. The limit that a particular engine can tolerate will depend on specific design factors. Resistance may be adjusted by design to permit the required gas flow rate, whilst allowing a back pressure compatible with engine function.

In one example the face mask may include two particulate removal devices as described herein. One device may be placed (in use) on either side of the mouth of the user, adjacent the user's cheeks. This face mask may have inlets for the two particulate removal devices facing rearward along the sides of the face at the outside of the face mask, with outlets for the two particulate removal devices facing toward, or to a location in front of, the mouth and nose at the inside of the face mask.

The size of the device may depend on its application.

The device may have dimensions (e.g. width, height, and length) of about 5 to 15 cm, about 5 to 15 cm and/or about 0.5 to 5 cm. The channel width and height may be 10 mm to 100 mm and the length may be 200 mm by 1000 mm.

Any of the above described features, including optional features may be applicable to any one or more or all of the above recited aspects of the invention.

Certain preferred embodiments on the present invention will now be described in greater detail, by way of example only and with reference to the accompanying drawings, in which:

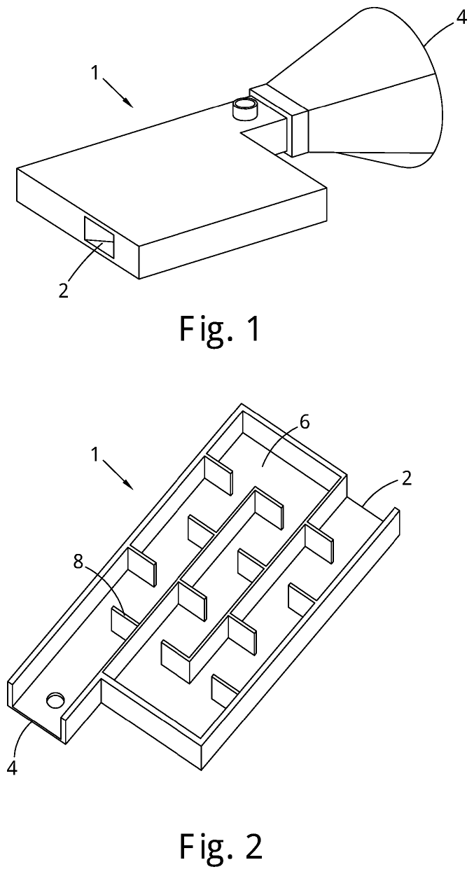

FIG. 1 shows a device for removal of particulates from a gas;

FIG. 2 shows a first internal configuration for the device;

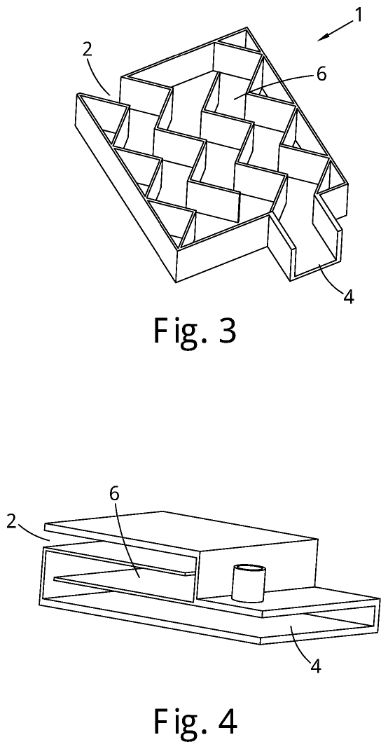

FIG. 3 shows a second internal configuration for the device;

FIG. 4 shows a third internal configuration for the device;

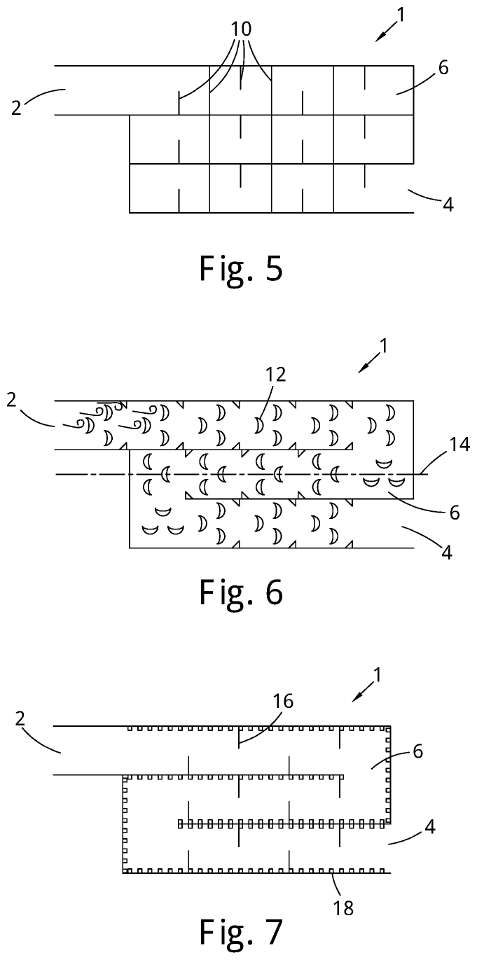

FIG. 5 shows a fourth internal configuration for the device;

FIG. 6 shows a fifth internal configuration for the device;

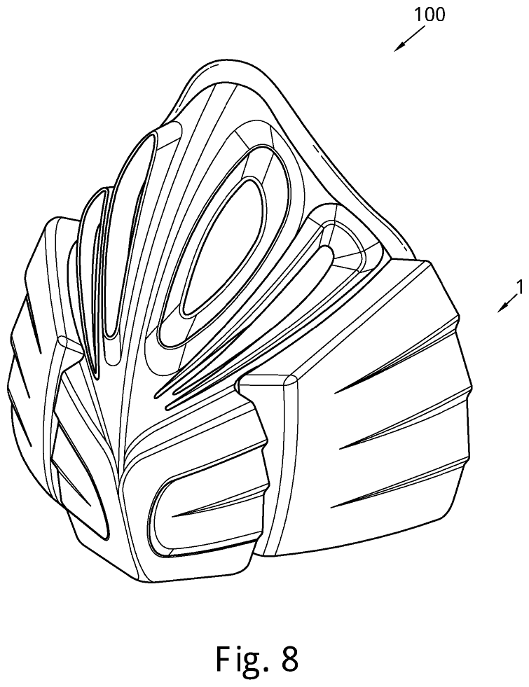

FIG. 7 shows a sixth internal configuration for the device;

FIG. 8 shows a front view of an exemplary face mask equipped with devices for removal of particulates;

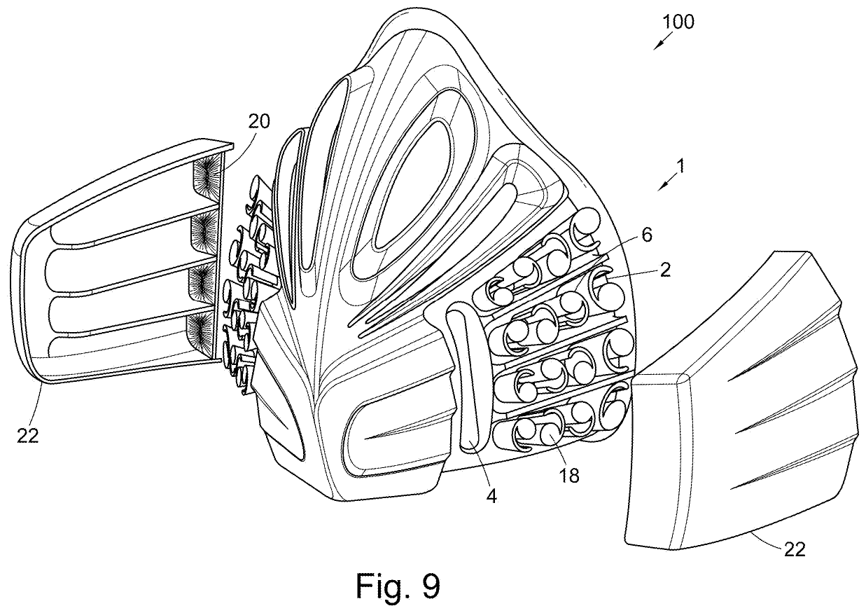

FIG. 9 shows the face mask of FIG. 8 in partially exploded view showing a seventh internal configuration for the devices;

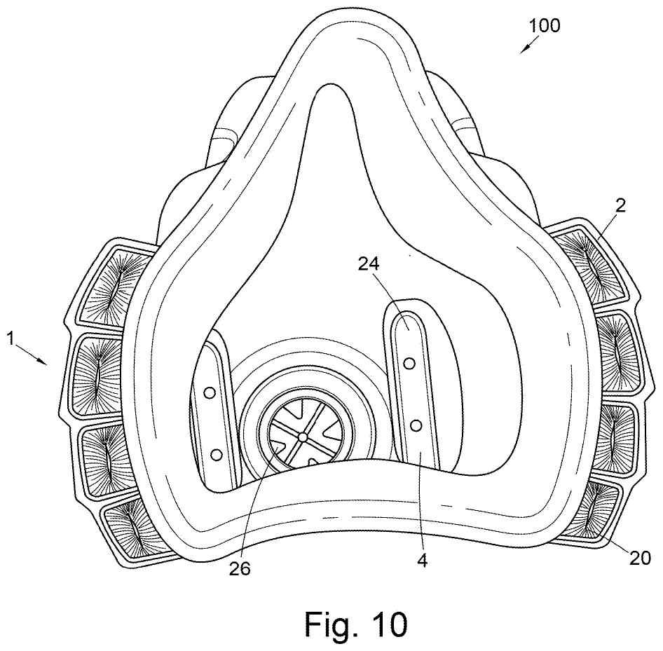

FIG. 10 is a rear view of the face mask of FIG. 8;

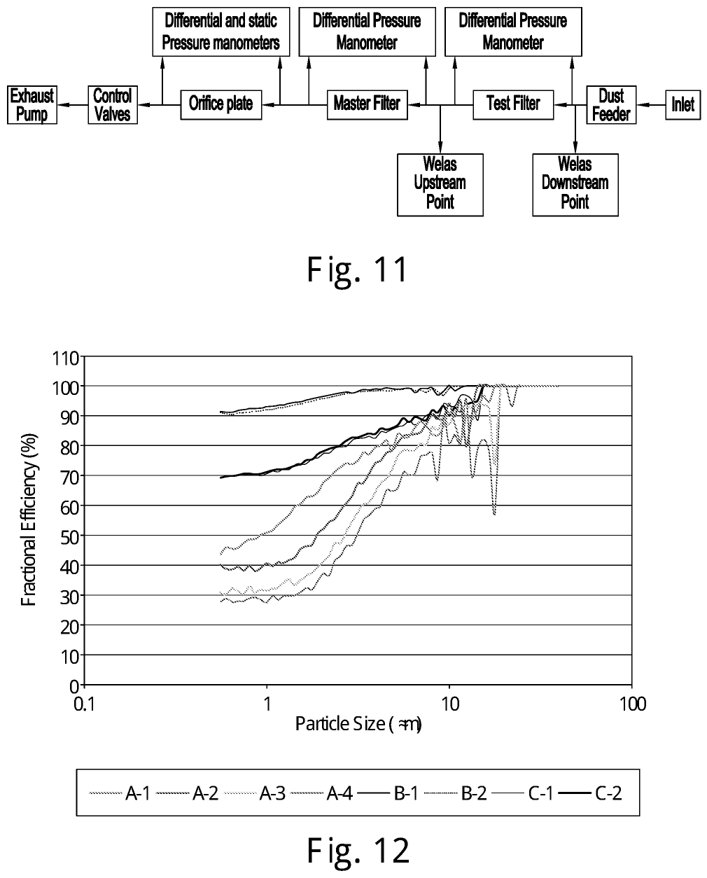

FIG. 11 shows schematically a test set up;

FIG. 12 shows some experimental results;

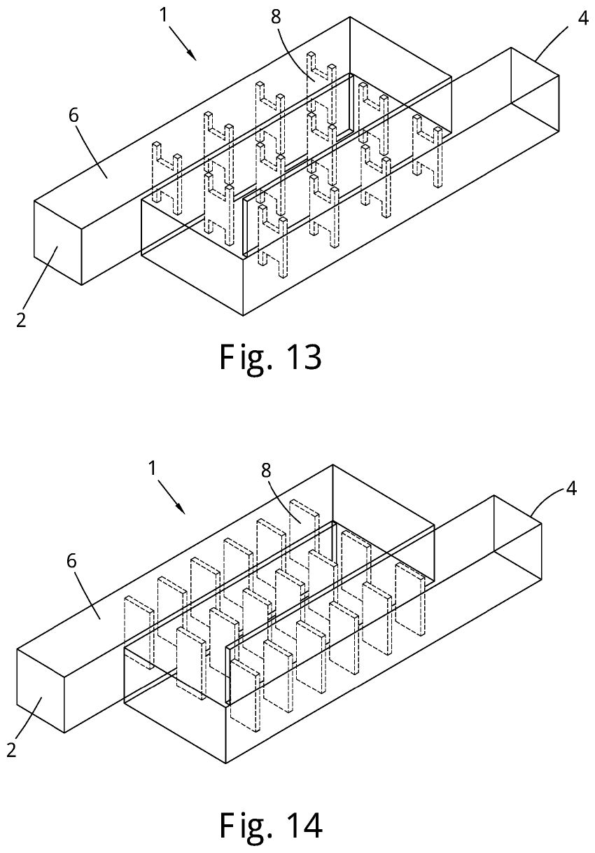

FIGS. 13, 14 and 15 shows configurations for the device that were analysed using computational fluid dynamics.

FIG. 1 shows a device 1 for removal of particulates from a gas. The device 1 comprises an inlet 2 for receiving a flow of gas and an outlet 4 from which the flow of gas can be expelled. Between the inlet 2 and outlet 4 is a labyrinthine path 6 for passage of the flow of gas. The labyrinthine path 6 is arranged to steer the flow of gas such that particulates in the gas will impact on adsorption surfaces of the labyrinthine path 6 arranged for adsorption of impacted particulates such that particulates in the gas are removed from the gas by impaction on the adsorption surfaces as the gas flows from the inlet 2 to the outlet 4. There may also be regions within the device 1 where the velocity magnitude of the air flow below 1 ms⁻¹ and/or is less than 10% of the average input air flow velocity. These may be referred to as regions of slow flow. The volume of slow flow regions in the device 1 may be at least 4% of the total volume of the device 1. The figures show a device with a cone at the outlet 4. This cone may not be present.

Various exemplary labyrinthine paths 6 are shown in FIGS. 2 to 7, 9 and 13 to 15. These examples are by no means exhaustive.

FIG. 2 shows a configuration with a serpentine flow path 6 with two 180 degree bends and a plurality of baffles 8 located in the flow path 6. The baffles 8 each extend across the full height of the flow path 6 and extend partially across the width of the flow path 6. The baffles 8 alternate between extending from opposite sides of the flow path 6. The baffles 8 each extend more than 50% across the width of the flow path 6. As a result, there is no straight line for the flow of gas through the flow path 6.

The length, width and height of the device 1 shown in FIG. 2 may for example be 106 mm×64 mm×24 mm. The inlet and internal section area may be 20 mm×20 mm. The length of each baffle may be 11 mm and the baffles may be 20 mm apart. The length of each of the two internal walls that form the serpentine path may be 85 mm.

FIG. 3 shows a configuration with a serpentine flow path 6 with two effectively 180 degree bends. The flow path 6 has angled walls that are angled into and away from the flow path to create a zig-zag-shaped flow path. The flow of gas through the device shown in FIG. 3 is forced to travel in a zig-zag path. The peak of the zig-zags may extend into one of the troughs of the zig-zag of an adjacent wall such that there is no straight line passage through the device for gas flow.

The length, width and height of the device 1 shown in FIG. 3 may for example be 90 mm×79 mm×24 mm. The inlet and internal section area may be 19.17 mm×20 mm. The length of each angled portion of the wall of the flow path may be 19.8 mm.

FIG. 4 shows a configuration with a wide but small height serpentine flow path 6 with two 180 degree bends.

The length, width and height of the device 1 shown in FIG. 4 may for example be 60 mm×84 mm×24 mm. The inlet and flow path may be 5 mm×40 mm. The length of each of the two walls that form the serpentine path may be 55 mm.

FIG. 5 shows a configuration with a serpentine flow path 6 with two 180 degree bends and a plurality of baffles 10 located in the flow path 6. The baffles 10 each extend fully across the height or width of the flow path 6 and extend partially across the other of the width or the height of the flow path 6. The baffles 10 alternate along the length of the path between extending from a first side towards a second opposite side, from the top towards the bottom, from the second side towards the first side, and from the bottom towards the top of the path 6.

The baffles 10 may each be equal in length but extend alternately along the length from one of the four walls of the flow path 6. Each baffle may extend into the flow path 6 by 1 cm.

The baffles may each extend across 60% of the width or height of the flow path 6. With this arrangement the gas flowing through the device 1 will be steered towards one side of the path, then the top of the flow path, then towards the other side, and then towards the bottom of the path 6. Again with this arrangement there is no straight line for the flow of gas through the flow path 6.

FIG. 6 shows a configuration with a serpentine flow path 6 with two 180 degree bends and a plurality of pegs 12 located in the flow path 6. The pegs 12 each extend fully across the height of the flow path 6. Along the length of the flow path the pegs 12 are located at varying locations across the width with some locations along the flow path having a single peg 12 at about the midpoint of the width of the path, some locations along the length having two pegs 12 (which may be smaller than the single central pegs 12) equally spaced wither side of the mid-point of the width of the path and at some locations having pegs 12 on either side that extend from the walls. As illustrated by line 14, the pegs 12 are arranged so there is no straight line across the device without encountering a peg 12.

The single central pegs may have a width that is about ⅓^{rd} the width of the flow path 6. At the locations where the pegs 12 extend from the walls on either side, the two pegs together may extend about ⅓^{rd} of the width of the path 6 leaving a gap f about ⅔^{rd} in the middle of the path 6.

The pegs 12 may each have a concave and/or curved surface that faces towards the direction of the oncoming flow of gas. This can help to create turbulence in the flow as illustrated at the upper left-hand side of FIG. 6.

FIG. 7 shows a configuration with a serpentine flow path 6 with two 180 degree bends and a plurality of baffles 16 located in the flow path 6. The baffles 16 each extend across the full height of the flow path 6 and extend partially across the width of the flow path 6. The baffles 16 alternate between extending from opposite sides of the flow path 6. The baffles 16 each extend more than 50% across the width of the flow path 6. As a result, there is no straight line for the flow of gas through the flow path 6.

All of the walls of the flow paths may have equally spaced ridges 18 thereon. These create recesses at the surface of the flow path 6 to help reduce the boundary layer. The gaps between the ridges 18 may be equal to approximately two times the height of the ridges. The ridges 18 may each extend about 1.5 mm into the flow path and thus the gap between each of the ridges may be about 3 mm.

FIGS. 8, 9 and 10 show a face mask 100 with two of the above particle removing devices 1 integrated therein. One device is placed on either side of the mouth of the user, adjacent the user's cheeks when the face mask is being worn.

Whilst FIG. 9 with the covers 22 removed shows devices 1 with yet another configuration for the labyrinthine path 6, the device could have the configuration shown in any of FIGS. 2 to 7 or any other configuration that would allow the particles to be removed by impaction onto deposition surfaces.

The configuration of each device shown in FIG. 9 comprises four parallel flow paths 6. Within each flow path 6 are four pegs 18. The pegs 18 each extend across the height of their respective flow path 6. The pegs 18 are comma-shaped and mimic the effect of turbinate bones in a human nose.

The pegs 18 create branches in the flow path that create turbulence in gas that flows through each flow path 6 and cause impaction of particles on deposition surfaces. Each flow path 6 has its own respective inlet 2 but the flow paths 6 of each device have a common outlet 4.

Each inlet 2 has bristles 20 over it. This allows large particles to be prevented from entering the device 1.

Each device has a cover 222 that can be removed. This allows the flow path of the device 1 to be easily washed to remove particulates that are captured by the device 1.

As shown most clearly in FIG. 10, the face mask comprises inlet and outlet one-way valves 24, 26 (that may be flutter valves for example). The inlet valve 24 is arranged to permit airflow from the inlet 2 of the device 1 to the outlet 4 of the device 1 and restricts or prevents airflow from the outlet 4 to the inlet 2. The outlet valve 26 is arranged to permit exhaled air to exit the face mask 100 and to restrict or prevent air flow from the outside environment without going through the device 1. When the pressure is low in the face mask 100 (such as during an inhalation by the user) air may be drawn in through the device 1 through the inlet valve 24 and when pressure is high in the face mask (such as during exhalation by the user) air may be forced out through the outlet valve 26.

As explained, the principles of the invention may be applied in the context of face mask 100 for a person. This for example can be a face mask 100 as used by cyclists or pedestrians in a city or other areas with potential air pollution. The device may also be used in other products, for example in relation to face masks used in other situations where particulates can be a problem, such as industrial environments, or in relation to air filter devices for purposes other than cleaning air during breathing, such as for cleaning of exhaust gases to remove particulates before they reach the atmosphere or air conditioning for buildings or environments such as aircraft.

FIGS. 13, 14 and 15 also show exemplary devices 1 with inlets 2 and outlets 4 between which there is a labyrinthine/serpentine path 6 in which is located baffles 8.

In each of these exemplary devices 1 the baffles are arranged so there is a clear line along at least part of each internal surface of the path 6 between turns.

In the device 1 in FIG. 13 the baffles 8 are suspended in the middle of the path by suspending members at the corners of the baffles 8. There is a clear line along the whole of each side surface is provided and along part of the top and bottom surfaces between and outside the suspending members.

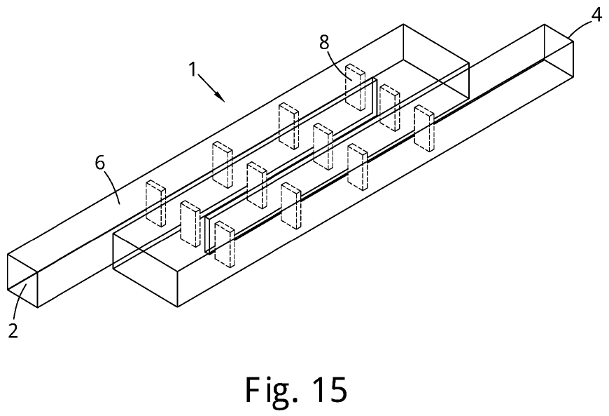

In the devices 1 of FIGS. 14 and 15 the baffles 8 extend between the top and bottom surfaces of the flow path 6. There is a clear line along the whole of each side surface and along part of the top and bottom surfaces around the baffles 8.

These devices 1 of FIGS. 13, 14 and 15 were the subject of computational fluid dynamics, the results of which are provided below.

### Experimental Data

Exemplary filters have undergone two rounds of testing. As an overview they were tested according to protocols as follows, ISO 5011:2014 (the multipass performance testing for inlet air cleaning equipment for internal combustion engines and compressors) and the BS EN 779:2012 specification (designed for the filtration performance testing of air filters used in air conditioning systems).

In both cases the set up was as shown schematically in FIG. 11.

The first round of testing used single sided “cassettes” that had adapters fitted to allow characteristics of the airflow upstream and downstream of the cassette to be measured. Protocols were followed by the testing agency to ensure a smooth repeatable airstream entering the device. Sufficient test dust was inserted into the airstream to reach the target concentration.

The second round of testing was on the Mk2 version of the device, which consisted of two “cassettes” and a joining piece representing the case where one cassette would be worn on each side of the face and the air breathed in through the joining piece. The internal structure of Mk2 (mark 2) was the same as the structure used in the first round of testing, except it had one “baffle” has been removed, and an extra full 180 degree turn is included as a result of the joining piece. This different arrangement is to mimic the fact that in the case of a face mask each of the two cassettes in use may be against one of the user's cheek and there may be a mouthpiece (i.e. the joining piece).

The first round of testing used an air flow of 240 lpm or 4 l/s and then this was varied to the following percentages of this standard flow, 50%, 75%, 100% and 125% and tested with dust concentration as in the table below.

The second round of testing used 120 lpm through each side, or 240 lpm through the whole mk2 dual filter.

TABLE 1
Air flow characteristics

| | |
|---|---|
| Air Flow | 240 lpm |
| Challenge Aerosol | ISO 12103-1 A1 Ultrafine |
| Target Concentration | 0.5 g/m³ |
| Duration | 4 Hours |

The fractional efficiency was determined using the Welas 3000 particle counter. Two samplers situated upstream and downstream of the device measured the number, size and concentration of the particles present. The upstream and downstream results were then compared and a fractional efficiency curve was generated as shown in FIG. 12. FIG. 12 shows the results from the first round of testing. The removal device tested in tests A and B had an internal structure corresponding to that shown in FIG. 2 and that tested in test C had an internal structure corresponding to that shown in FIG. 3.

The figure shows excellent particle removal especially for the fine fractions with as much as 90% removal of the finest particle fractions (approximating to PM₁), the different lines refer to different variations of the internal structure of the filters. The lines marked B-1, and B-2 for example are for the filter with a maze like internal structure as shown in FIG. 2, these are results of 2 separate tests. We see a reduction of between 40 and 90% of the PM1 sized particles depending on internal structure of the filter. These results are from the simple cassettes (i.e. the first round of testing), the second round of experiments had amendments to the filters as discussed above to better reflect their use as part of a mask. Specifically each cassette had one baffle removed and a 180 degree bend introduced as part of the mouthpiece. The changes were intended to keep a similar pressure drop but with a more realistic form factor. The results from the amended test were still in the range of a 40-90% reduction in PM1's, but nearer to the 40% end of the spectrum.

Computational Fluid Dynamics

Additionally, computational fluid dynamics (CFD) has been carried out to assess the effectiveness of various device geometries.

Steady-state CFD analysis at a single operating condition was undertaken in each of the device geometries, simulating airflow via a Reynolds Averaged Navier-Stokes (RANS) approach, and particle transport via a Turbulent Dispersion model.

Air flow was modelled using a Lag EB K-Epsilon RANS approach, which is well suited for flows subject to rotation or strong streamline curvature. An inflow rate of 120 L/min was applied at the inflow of each device. The pressure drop for a given device was defined as the pressure difference between the inflow and outflow.

Particulate transport was modelled using a Lagrangian multiphase approach, with particles subject to a drag Force (Schiller-Naumann), a pressure gradient force, and turbulent dispersion. A particulate concentration of 0.5 g/m³ was applied at the Inflow. Particulate material density was set to 2600 kg/m³, which is representative of ISO 12103-1 A1 Ultrafine Test Dust. All particles were assumed to have a diameter of 1 micron. Particulate interaction with the solid walls was modelled using an escape/rebound condition parameterised by a critical velocity VC, and a restitution coefficient C_{R}, where V_{C}=1.2 m/s and C_{R}=0.4. The Filtration Rate (for 1 micron particles) for a given device was defined as:

[1−(C_{O}/C_{I})]×100%

where C_{O} is the 1 micron particulate count at the outflow and C_{I} is the 1 micron particulate count at the inflow.

TABLE 2

| | Cross | | | | | | Approximate | | Volume of |
|---|---|---|---|---|---|---|---|---|---|
| | sectional | Approximate | | Net volume | Net volume | Pressure | filtration rate | Volume of | slow flow |
| | area | path length | Volume | less baffles | less baffles | drop | (% of PM₁ | Slow Flow | as % of |
| Device | (m³) | (m) | calculation | (mm³) | (m³) | (mbar) | removed) | (m³) | total volume |
| FIG. 13 | 0.0004 | 0.3 | 144460 | 144460 | 0.00014 | 2.9 | 39 | 0.0000066 | 4.6% |
| FIG. 14 | 0 0004 | 0.3 | 141400 | 141400 | 0.00014 | 4.9 | 42 | 0.000012 | 8.5% |
| FIG. 15 | 0.0001 | 0.3 | 38035 | 38035 | 0.00004 | 105.1 | 6.5 | 0.000000011 | 0.3% |

Table 2 shows results from the CFD for the devices shown in FIGS. 13, 14 and 15

The lowest pressure drop for the device of FIG. 13 is likely due to the reduced surface area of each baffle, and the clear line-of sight along each path between the turns in the path.

The devices of FIGS. 13 and 14 have similar Filtration Rates (˜40%). The device of FIG. 15 has a significantly lower filtration rate (6.5%). The significantly lower filtration rate for this device may be due to the increased flow velocity, which is a consequence of the reduced channel area.

For a given device a Volume of Slow Flow may be defined as the volume of air with a velocity magnitude below 1 ms⁻¹.

The devices shown in FIGS. 13 and 14 have the highest Volumes of Slow Flow, and also have the lowest predicted Pressure Drops and the highest predicted Filtration Rates.

The following clauses set out features of the invention that may not presently be claimed but which may provide basis for future claims and/or one or more divisional applications.
1. A device for removal of particulates from a gas, the device comprising:
   an inlet for receiving a flow of gas;
   an outlet from which the flow of gas can be expelled; and
   a labyrinthine path extending between the inlet and the outlet for passage of the flow of gas;
   wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet.
2. A device for removal of particulates from a gas, the device comprising:
   an inlet for receiving a flow of gas;
   an outlet from which the flow of gas can be expelled; and
   a labyrinthine path extending between the inlet and the outlet for passage of the gas;
   wherein the labyrinthine path steers the flow of gas such that particulates in the flow of gas impact on deposition surfaces of the labyrinthine path arranged for deposition of impacted particulates such that particulates in the gas are removed from the gas by impaction on the deposition surfaces as the gas flows from the inlet to the outlet,
   wherein the device has a continuous gas path from the inlet to the outlet.
3. A device according to clause 1 or 2, wherein the labyrinthine path is arranged to steer the flow of gas through and/or past multiple turns and/or branches with changes in the flow direction.
4. A device according to clause 3, wherein the changes in the flow direction are at least 90 degrees.
5. A device according to any preceding clause, wherein the walls of the labyrinthine path include surfaces extending along the principal flow direction and surfaces that are at least 90 degrees relative to the flow of gas, such that particulates in the flow of gas impact on the walls of the labyrinthine path.
6. A device according to any preceding clause, wherein the walls of the labyrinthine path consist of non-porous and/or non-absorptive materials.
7. A device according to any preceding clause, wherein, in use, the gas does not pass through a fluid.
8. A device according to any preceding clause, wherein the device does not comprise a filter.
9. A device according to any preceding clause, wherein the device comprises multiple flow paths coupled together in parallel between the inlet and the outlet of the device.
10. A device according to any preceding clause, wherein the path between the inlet and the outlet comprises a serpentine path.
11. A device according to any preceding clause, wherein the path comprises branches that are for the capture of particulates rather than for through-flow of the gas.
12. A device according to any preceding clause, wherein the walls of the labyrinthine path have a textured, roughened or fibrous surface.
13. A device according to any preceding clause, wherein the device comprises protrusions that extend into and/or across the flow path.
14. A device according to any preceding clause, wherein the device comprises pegs in the flow path that mimic the turbinate bones of the human nose.
15. A device according to any preceding clause, wherein the maximum length of straight line passages within the labyrinthine path is up to 2 times the width of the path.
16. A device according to any preceding clause, wherein the device comprises baffles.
17. A device according to clause 16, wherein each baffle extends at least 50% into the flow path.
18. A device according to clause 16 or 17, wherein the baffles are located as alternating top and bottom baffles along the length of the path.
19. A device according to clause 16 or 17, wherein the baffles alternate along the length of the path between extending from a first side towards a second opposite side, from the top or bottom towards the other of the bottom or the top, from the second side towards the first side, and from the other of the bottom or the top towards the other of the top or the bottom of the path.
20. A device according to any preceding clause, wherein the device comprises protrusions in the form of ridges that extend across and from the walls of the path and that form recesses at the walls of the path.
21. A device according to any clause 20, wherein the height of the ridges are smaller than a twentieth of the width and/or height of the path.
22. A device according to any preceding clause, wherein the device comprises pegs that extend across the path.
23. A device according to clause 22, wherein the pegs are concaved and/or curved and wherein the concave and/or curved surface of the peg, in use, faces into the oncoming gas flow.
24. A device according to any preceding clause, wherein the walls of the path are angled into and out of the path alternately so as to cause the gas to flow in a zig-zag path through the device.
25. A device according to any preceding clause, wherein the device comprises protrusions in the flow path of two different size scales relative to the size of the width of the path.
26. A device according to any preceding clause, wherein the gas flow path of the device includes a bend of between 90-180 degrees after the labyrinthine path.
27. A device according to any preceding clause, wherein the device comprises bristles that are located across the path at, or near, the inlet of the device.
28. A device according to any preceding clause, wherein the device comprises a one-way valve, the valve being arranged to permit airflow from the inlet to the outlet and to restrict or prevent airflow from the outlet to the inlet.
29. A device according to any preceding clause, wherein the walls of the gas flow path are made of acrylonitrile butadiene styrene (ABS).
30. A device according to any preceding clause, wherein the internal walls of the device are made from a material that is antibacterial and/or antiviral.
31. A device according to any preceding clause, wherein the walls of the labyrinthine path are electrostatically charged.
32. A device according to any preceding clause, wherein the device has a removable cover to aid cleaning of the labyrinthine path.
33. A device according to any preceding clause, wherein the device has dimensions of 5 to 15 cm, by 5 to 15 cm, by 0.5 to 5 cm.
34. A device according to any preceding clause, wherein the device is arranged to allow a peak inspiratory flow rate of up to 300 litres/minute.
35. A device according to any preceding clause, wherein the device is arranged to have inspiratory resistances of <8 mm H₂O/L/sec
36. A device according to any preceding clause, wherein the device is arranged to remove particles smaller than 1 micron from air by impaction on adsorption surfaces.
37. A face mask, the face mask comprising the device of any preceding clause.
38. A face mask according to clause 37, wherein the device is an integral part of the face mask.
39. A face mask according to clause 37 or 38, wherein the inlet for the device faces rearward relative to the face of the user when the face mask is worn by a user.
40. A face mask according to clause 37, 38 or 39, wherein the face mask has an exhale valve that allows exhaled air to exit the face mask without going back through the device.
41. A face mask according to any of clauses 37 to 40, wherein the outlet of the device is directed on to an internal surface of the face mask that is, in use, in front of the nose and/or mouth of the user.
42. A face mask according to any of clauses 37 to 41, wherein the face mask comprises two devices, wherein one device is placed, in use, on either side of the mouth of the user, adjacent the user's cheeks.
43. A method of removing particulates from a gas, the method comprising:
   providing a device for removal of particulates from a gas, the device comprising:
      an inlet for receiving a flow of gas;
      an outlet from which the flow of gas can be expelled; and
      a labyrinthine path extending between the inlet and the outlet for passage of the gas;
   passing a flow of gas through the device from the inlet to the outlet,
   wherein the labyrinthine path steers the flow of gas such that particulates in the gas impact on adsorption surfaces of the labyrinthine path arranged for adsorption of impacted particulates such that particulates in the gas are removed from the gas by impaction on the adsorption surfaces as the gas flows from the inlet to the outlet.
44. A method according to clause 43, wherein the device is a device according to any of clauses 1 to 36.
45. A method according to clause 43 or 44, wherein the method is for cleaning air that is about to breathed in by a person.
46. A method according to clause 43 or 44, wherein the method is for cleaning air at a source where the pollutants are created to prevent them being released into the atmosphere.
47. A method of removing particulates from a gas, the method comprising:
providing the face mask of any of clauses 37 to 42, and
   passing a gas through the device from the inlet to the outlet.

1. A face mask comprising a device for removal of solid particulates from a gas, the device comprising:
an inlet for receiving a flow of gas;
an outlet from which the flow of gas can be expelled; and
a labyrinthine path extending between the inlet and the outlet for passage of the flow of gas;
wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet.

2. A face mask according to claim 1, wherein in use, the volume of air in the device with a velocity magnitude below 1 ms⁻¹ is greater than 4% of the total volume of air in the device.

3. A face mask according to claim 1 or 2, wherein in use, the pressure drop between the inlet and outlet is less than 10 mb.

4. A facemask according to claim 1, 2 or 3, wherein the walls of the labyrinthine path consist of non-porous and/or non-absorptive materials.

5. A face mask according to any preceding claim, wherein the device has a continuous gas path from the inlet to the outlet.

6. A face mask according to any preceding claim, wherein the labyrinthine path is arranged to steer the flow of gas through and/or past multiple turns and/or branches with changes in the flow direction of at least 90 degrees.

7. A face mask according to any preceding claim, wherein the walls of the labyrinthine path include surfaces extending along the principal flow direction and surfaces that are at least 90 degrees relative to the flow of gas, such that particulates in the flow of gas impact on the walls of the labyrinthine path.

8. A face mask according to any preceding claim, wherein, in use, the gas does not pass through a fluid.

9. A face mask according to any preceding claim, wherein the face mask does not comprise a filter.

10. A face mask according to any preceding claim, wherein the path comprises branches that are for the capture of particulates rather than for through-flow of the gas.

11. A face mask according to any preceding claim, wherein the device comprises baffles.

12. A face mask according to claim 11, wherein each baffle has an area that is between 10% and 90% of the cross sectional area of the path cross sectional area.

13. A face mask according to claim 11 or 12, wherein the baffles are located such that a clear line is present along at least part of all edges of the path until there is a turn in the path.

14. A face mask according to claim 11, 12 or 13, wherein the baffles are suspended in the middle of the path by members that each have a width that is less than 20% of the width of the channel.

15. A face mask according to any of claims 11 to 14, wherein the spacing between each baffle is between 50% and 300% of the cross sectional diameter of the path.

16. A face mask according to any of claims 11 to 15, wherein the baffles are shaped between concave and convex, such that the centre of each baffle is deflected by no more than +/−75% of the width of the baffle from its edges.

17. A face mask according to any preceding claim, wherein the gas flow path of the face mask includes a bend of between 90-180 degrees after the labyrinthine path.

18. A face mask according to any preceding claim, wherein the face mask comprises bristles that are located across the path at, or near, the inlet of the device.

19. A face mask according to any preceding claim, wherein the walls of the gas flow path are made of acrylonitrile butadiene styrene (ABS).

20. A face mask according to any preceding claim, wherein the device has a removable cover to aid cleaning of the labyrinthine path.

21. A face mask according to any preceding claim, wherein the device has dimensions of 5 to 15 cm, by 5 to 15 cm, by 0.5 to 5 cm.

22. A face mask according to any preceding claim, wherein the face mask comprises a second device for removal of solid particulates from a gas, the second device comprising: an inlet for receiving a flow of gas; an outlet from which the flow of gas can be expelled; and a labyrinthine path extending between the inlet and the outlet for passage of the flow of gas; wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet, wherein one device is placed, in use, on either side of the mouth of the user, adjacent the user's cheeks.

23. A method of removing particulates from a gas, the method comprising:
providing a face mask comprising a device for removal of solid particulates from a gas, the device comprising:
an inlet for receiving a flow of gas;
an outlet from which the flow of gas can be expelled; and
a labyrinthine path extending between the inlet and the outlet for passage of the gas;
passing a flow of gas through the device from the inlet to the outlet,
wherein the labyrinthine path steers the flow of gas such that particulates in the gas impact on adsorption surfaces of the labyrinthine path arranged for adsorption of impacted particulates such that particulates in the gas are removed from the gas by impaction on the adsorption surfaces as the gas flows from the inlet to the outlet.

24. A method according to claim 23, wherein the face mask is a face mask according to any of claims 1 to 22.

25. A device for removal of particulates from a gas, the device comprising:
an inlet for receiving a flow of gas;
an outlet from which the flow of gas can be expelled; and
a labyrinthine path extending between the inlet and the outlet for passage of the flow of gas;
wherein the labyrinthine path is arranged to steer the flow of gas such that particulates in the gas will impact on adsorption surfaces of the labyrinthine path arranged for adsorption of impacted particulates such that particulates in the gas are removed from the gas by impaction on the adsorption surfaces as the gas flows from the inlet to the outlet, wherein in use, the volume of air in the device with a velocity magnitude below 1 ms⁻¹ is greater than 4% of the total volume of air in the device.

26. A device according to claim 25, wherein the pressure drop between the inlet and outlet is less than 10 mbar.

27. A device according to claim 25 or 26, wherein the labyrinthine path is arranged to steer the flow of gas through and/or past multiple turns and/or branches with changes in the flow direction of at least 90 degrees.

28. A device according to claim 25, 26 or 27, wherein the walls of the labyrinthine path include surfaces extending along the principal flow direction and surfaces that are at least 90 degrees relative to the flow of gas, such that particulates in the flow of gas impact on the walls of the labyrinthine path.

29. A device according to any of claims 25 to 28, wherein the walls of the labyrinthine path consist of non-porous and/or non-absorptive materials.

30. A device according to any of claims 25 to 29, wherein, in use, the gas does not pass through a fluid.

31. A device according to any of claims 25 to 30, wherein the device does not comprise a filter.

32. A device according to any of claims 25 to 31, wherein the path comprises branches that are for the capture of particulates rather than for through-flow of the gas.

33. A device according to any of claims 25 to 32, wherein the walls of the labyrinthine path have a textured, roughened or fibrous surface.

34. A device according to any of claims 25 to 33, wherein the device comprises baffles.

35. A device according to claim 34, wherein each baffle has an area that is between 10% and 90% of the cross sectional area of the path cross sectional area.

36. A device according to claim 34 or 35, wherein the baffles are located such that a clear line is present along at least part of all four edges of the path until there is a turn in the path.

37. A device according to claim 34, 35 or 36, wherein the baffles are suspended by members that each have a width that is less than 20% of the width of the path.

38. A device according to any of claims 34 to 37, wherein the spacing between each baffle is between 50% and 300% of the cross sectional diameter of the path.

39. A device according to any of claims 34 to 38, wherein the baffles are shaped between concave and convex, such that the centre of each baffle is deflected by no more than +/−75% of the width of the baffle from its edges.

40. A device according to any of claims 25 to 39, wherein the gas flow path of the device includes a bend of between 90-180 degrees after the labyrinthine path.

41. A device according to any of claims 25 to 40, wherein the device comprises bristles that are located across the path at, or near, the inlet of the device.

42. A device according to any of claims 25 to 41, wherein the walls of the gas flow path are made of acrylonitrile butadiene styrene (ABS).

43. A device according to any of claims 25 to 42, wherein the device has a removable cover to aid cleaning of the labyrinthine path.

44. A device according to any of claims 25 to 43, wherein the device has dimensions of 5 to 15 cm, by 5 to 15 cm, by 0.5 to 5 cm.

45. A device according to any of claims 25 to 44, wherein the device is arranged to allow a peak inspiratory flow rate of up to 300 litres/minute.

46. A face mask, the face mask comprising the device of any of claims 25 to 45.

47. A face mask according to claim 46, wherein the device is an integral part of the face mask.

48. A face mask according to claim 46 or 47, wherein the inlet for the device faces rearward relative to the face of the user when the face mask is worn by a user.

49. A face mask according to claim 46, 47 or 48, wherein the face mask has an exhale valve that allows exhaled air to exit the face mask without going back through the device.

50. A face mask according to any of claims 46 to 49, wherein the outlet of the device is directed on to an internal surface of the face mask that is, in use, in front of the nose and/or mouth of the user.

51. A face mask according to any of claims 46 to 50, wherein the face mask comprises two devices according to any of claims 25 to 45, wherein one device is placed, in use, on either side of the mouth of the user, adjacent the user's cheeks.

52. A face mask according to any of claims 46 to 51, wherein the face mask is a face mask according to any of claims 1 to 22.

53. A method of removing particulates from a gas, the method comprising:
providing a device for removal of particulates from a gas, the device comprising:
an inlet for receiving a flow of gas;
an outlet from which the flow of gas can be expelled; and
a labyrinthine path extending between the inlet and the outlet for passage of the gas;
passing a flow of gas through the device from the inlet to the outlet,
wherein the labyrinthine path steers the flow of gas such that particulates in the gas impact on adsorption surfaces of the labyrinthine path arranged for adsorption of impacted particulates such that particulates in the gas are removed from the gas by impaction on the adsorption surfaces as the gas flows from the inlet to the outlet, wherein in use, the volume of air in the device with a velocity magnitude below 1 ms⁻¹ is greater than 4% of the total volume of air in the device.

54. A method according to claim 53, wherein the device is a device according to any of claims 25 to 45.

55. A method according to claim 53 or 54, wherein the method is for cleaning air that is about to breathed in by a person.

56. A method according to claim 53 or 54, wherein the method is for cleaning air at a source where the pollutants are created to prevent them being released into the atmosphere.

57. A method of removing particulates from a gas, the method comprising:
providing the face mask of any of claims 46 to 52, and
passing a gas through the device from the inlet to the outlet.
